(19) United States
(12) Patent Application Publication
(10) Pub. No.: US 2024/0046840 A1
(43) Pub. Date: Feb. 8, 2024

(54) DISPLAY DEVICE, DRIVING METHOD THEREOF, AND DISPLAY EQUIPMENT

(71) Applicant: TCL CHINA STAR OPTOELECTRONICS TECHNOLOGY CO., LTD., Shenzhen, Guangdong (CN)

(72) Inventors: Yizhuo ZHAO, Shenzhen, Guangdong (CN); Qiusheng HUANG, Shenzhen, Guangdong (CN); Yuhua CHANG, Shenzhen, Guangdong (CN); Bin ZHAO, Shenzhen, Guangdong (CN)

(21) Appl. No.: 17/422,986

(22) PCT Filed: May 31, 2021
(86) PCT No.: PCT/CN2021/097218

§ 371 Date: Sep. 26, 2023

(30) Foreign Application Priority Data
Dec. 4, 2020 (CN) 202011411205.0

(51) Int. Cl. G09G 3/20

(52) U.S. Cl. CPC G09G 3/2018; G09G 2340/0435; G09G 2320/0247; G09G 2320/0673; G09G 2320/0233; G09G 2330/021; G09G 2320/0276

(57) ABSTRACT

A display device, a driving method thereof, and a display equipment are provided. The display device includes a driving module. The present disclosure allows a display panel to maintain a same brightness for image display when the display panel refreshes images at different refresh rates by allowing the refresh rates to correspond to gamma voltages and adjusting the gamma voltages to adjust a brightness of the display panel when a current refresh rate of the display panel changes. Serious flickers of the display device caused by the display device being switched at different refresh rates in a short time can be prevented.

### FIELD OF INVENTION

The present disclosure relates to the field of display technologies, and more particularly, to a display device, a driving method thereof, and a display equipment.

### BACKGROUND OF INVENTION

Display devices usually refresh at a certain fixed frequency when displaying, while under some specific conditions, the display devices are required to display at a higher or lower refresh rate. However, an interval time between two frames when displaying at the lower refresh rate is longer than an interval time between two frames when displaying at the higher refresh rate. An overly long interval time will aggravate an impact of electrical leakage of the display devices, and will finally reduce entire brightness of the display devices. Therefore, when the display devices are required to be switched at different refresh rates in a short time, the display devices will have serious flickers due to a brightness difference of the display devices at different refresh rates.

### SUMMARY OF INVENTION

### Technical Problem

The interval time between the two frames when displaying at the lower refresh rate is longer than the interval time between the two frames when displaying at the higher refresh rate. The overly long interval time will aggravate the impact of electrical leakage of the display devices, and will finally reduce the entire brightness of the display devices.

### Technical Solution to the Problem

### Technical Solution

An embodiment of the present disclosure provides a display device, a driving method thereof, and a display equipment to solve following technical problems in current display devices: when display devices are required to be switched at different refresh rates in a short time, the display devices will have serious flickers due to a brightness difference of the display devices at different refresh rates.

In order to solve the above problems, the present disclosure provides technical solutions as follows.

In a first aspect, the present disclosure provides a display device, which includes a driving module, a display panel, and a power control module;
wherein the driving module is configured to send driving signals to the display panel to control the display panel to refresh images at different refresh rates; and
the power control module is configured to provide gamma voltages corresponding to the refresh rates of the display panel to the display panel according to the refresh rates of the display panel to allow the display panel to maintain a default brightness for image display when the display panel refreshes the images at different refresh rates.

In some embodiments, the power control module includes a first control module and a power management module;
the driving module is further configured to send enable signals to the first control module when sending the driving signals to the display panel;
the first control module is configured to confirm the refresh rates of the display panel according to the enable signals; and
the power management module is configured to provide the gamma voltages corresponding to the refresh rates of the display panel to the display panel according to the refresh rates of the display panel.

In some embodiments, the first control module is further configured to send control signals to the power management module when a current refresh rate of the display panel is switched from a first frequency to a second frequency; and
the power management module is further configured to provide the display panel with a gamma voltage corresponding to the second frequency according to the control signals.

In some embodiments, the power management module includes a storage module configured to store data of the gamma voltages, the storage module includes a first memory device and a second memory device, the first memory device is configured to store data of a first gamma voltage, and the second memory device is configured to store data of a second gamma voltage.

In some embodiments, the power management module is further configured to provide the display panel with the gamma voltage corresponding to the second frequency according to the control signals sent by the first control module when the current refresh rate of the display panel is switched from the first frequency to the second frequency and the gamma voltage corresponding to the second frequency is the first gamma voltage or the second gamma voltage.

In some embodiments, the power management module is further configured to obtain the first gamma voltage from the first memory device and provide the first gamma voltage to the display panel according to the control signals sent by the first control module when the gamma voltage corresponding to the second frequency is the first gamma voltage.

In some embodiments, the power management module is further configured to obtain the second gamma voltage from the second memory device and provide the second gamma voltage to the display panel according to the control signals sent by the first control module when the gamma voltage corresponding to the second frequency is the second gamma voltage.

In some embodiments, the first control module is further configured to send data of the gamma voltage corresponding to the second frequency to the power management module when the current refresh rate of the display panel is switched from the first frequency to the second frequency and the gamma voltage corresponding to the second frequency is different from the first gamma voltage and the second gamma voltage; and
the power management module is further configured to amend the data in the first memory device or the second memory device to the data of the gamma voltage corresponding to the second frequency according to the data of the gamma voltage corresponding to the second frequency sent by the first control module.

In some embodiments, the gamma voltages correspond to refresh rate ranges by one to one.

In a second aspect, the present disclosure further provides a display equipment, which includes a display device, wherein, the display device includes a driving module, a display panel, and a power control module;
wherein the driving module is configured to send driving signals to the display panel to control the display panel to refresh images at different refresh rates; and
the power control module is configured to provide gamma voltages corresponding to the refresh rates of the display panel to the display panel according to the refresh rates of the display panel to allow the display panel to maintain a default brightness for image display when the display panel refreshes the images at different refresh rates;
wherein the power control module includes a first control module and a power management module;
the driving module is further configured to send enable signals to the first control module when sending the driving signals to the display panel;
the first control module is configured to confirm the refresh rates of the display panel according to the enable signals; and
the power management module is configured to provide the gamma voltages corresponding to the refresh rates of the display panel to the display panel according to the refresh rates of the display panel.

In some embodiments, the first control module is further configured to send control signals to the power management module when a current refresh rate of the display panel is switched from a first frequency to a second frequency; and the power management module is further configured to provide the display panel with a gamma voltage corresponding to the second frequency according to the control signals.

In some embodiments, the power management module includes a storage module configured to store data of the gamma voltages, the storage module includes a first memory device and a second memory device, the first memory device is configured to store data of a first gamma voltage, and the second memory device is configured to store data of a second gamma voltage.

In some embodiments, the power management module is further configured to provide the display panel with the gamma voltage corresponding to the second frequency according to the control signals sent by the first control module when the current refresh rate of the display panel is switched from the first frequency to the second frequency and the gamma voltage corresponding to the second frequency is the first gamma voltage or the second gamma voltage.

In some embodiments, the power management module is further configured to obtain the first gamma voltage from the first memory device and provide the first gamma voltage to the display panel according to the control signals sent by the first control module when the gamma voltage corresponding to the second frequency is the first gamma voltage.

In some embodiments, the power management module is further configured to obtain the second gamma voltage from the second memory device and provide the second gamma voltage to the display panel according to the control signals sent by the first control module when the gamma voltage corresponding to the second frequency is the second gamma voltage.

In some embodiments, the first control module is further configured to send data of the gamma voltage corresponding to the second frequency to the power management module when the current refresh rate of the display panel is switched from the first frequency to the second frequency and the gamma voltage corresponding to the second frequency is different from the first gamma voltage and the second gamma voltage; and the power management module is further configured to amend the data in the first memory device or the second memory device to the data of the gamma voltage corresponding to the second frequency according to the data of the gamma voltage corresponding to the second frequency sent by the first control module.

In some embodiments, the gamma voltages correspond to refresh rate ranges by one to one.

In a third aspect, the present disclosure further provides a driving method of a display device. The display device includes a driving module, a display panel, and a power control module, and the driving method of the display device includes following steps:
S10: the driving module sending driving signals to the display panel to control the display panel to refresh images at different refresh rates; and
S20: the power control module providing gamma voltages corresponding to the refresh rates of the display panel to the display panel according to the refresh rates of the display panel to allow the display panel to maintain a default brightness for image display when the display panel refreshes the images at different refresh rates.

### Beneficial Effect of the Invention

### Beneficial Effect

Beneficial effects of the present disclosure are that by allowing the refresh rates to correspond to the gamma voltages, a displayed brightness of the display panel can be adjusted by adjusting the gamma voltages provided to the display panel when the current refresh rate of the display panel changes. Therefore, a brightness difference of the display panel can be improved when the display panel refreshes the images at a lower refresh rate and a higher refresh rate by improving the displayed brightness when the display panel refreshes the images at the lower refresh rate and/or reducing the displayed brightness when the display panel refreshes the images at the higher refresh rate. The display panel is allowed to maintain a same brightness for image display when the display panel refreshes the images at different refresh rates. Therefore, serious flickers of the display device caused by the display device being switched at different refresh rates in a short time can be prevented.

### DESCRIPTION OF DRAWINGS

FIG. 1 is a schematic structural diagram of a display device according to an embodiment of the present disclosure.

FIG. 2 is a schematic structural diagram of the display device according to another embodiment of the present disclosure.

FIG. 3 is a schematic signal diagram of enable signals and control signals when switching refresh rates according to an embodiment of the present disclosure.

FIG. 4 is a schematic structural diagram of the display device according to yet another embodiment of the present disclosure.

FIG. 5 is a schematic signal diagram of gamma voltages provided by a power management module according to an embodiment of the present disclosure.

FIG. 6 is a schematic signal diagram of the gamma voltages provided by the power management module according to another embodiment of the present disclosure.

FIG. 7 is a schematic structural diagram of the power management module according to an embodiment of the present disclosure.

FIG. 8 is a flowchart of a driving method of the display device according to an embodiment of the present disclosure.

Elements in the drawings are designated by reference numerals listed below.

10. driving module; 20. display panel; 30. power control module; 31. first control module; 32. power management module; 321. storage module; 322. digital to analog converter; 323. low dropout linear regulator; and 324. gamma correction module.

### DETAILED DESCRIPTION OF PREFERRED EMBODIMENTS

In order to make the purpose, technical solutions, and effects of the present disclosure clearer and more definite, the following further describes the present disclosure in detail with reference to the drawings and embodiments. It should be understood that the specific embodiments described herein are only used to explain the disclosure, and are not used to limit the disclosure.

The present disclosure is dedicated to following technical problems in current display devices: when display devices are required to be switched at different refresh rates in a short time, the display devices will have serious flickers due to a brightness difference of the display devices at different refresh rates.

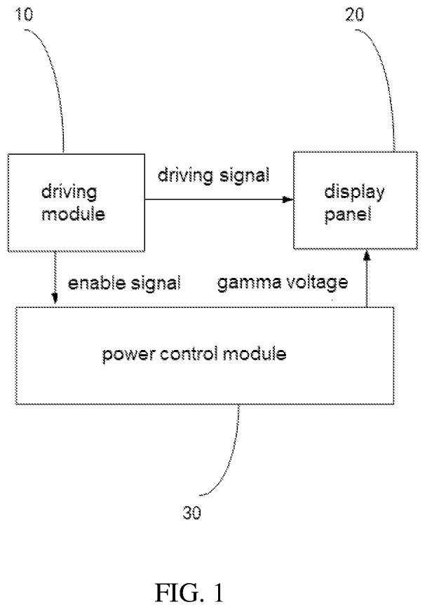

A display device, as shown in FIG. 1, includes a driving module 10, a display panel 20, and a power control module 30. The display device is a display device equipped with Free Sync (screen adaptive synchronization) technology.

Wherein, the driving module 10 is connected to the display panel 20 and the power control module 30. The driving module 10 is configured to send driving signals to the display panel 20 to control the display panel 20 to refresh images at different refresh rates. The power control module 30 is connected to the display panel 20. The power control module 30 is configured to provide gamma voltages corresponding to the refresh rates of the display panel 20 to the display panel 20 according to the refresh rates of the display panel 20 to allow the display panel 20 to maintain a default brightness for image display when the display panel 20 refreshes the images at different refresh rates.

It should be noted that the driving module 10 may be a screen driver board (timer control register, TCON), and the driving module 10 sends the driving signals to components such as a source driver and a scan driver of the display panel 20 to control the source driver and the scan driver to drive the display panel 20.

It should be noted that the driving module 10 is further configured to send enable signals to the power control module 30 when sending the driving signals to the display panel 20, and the power control module 30 confirms the refresh rates of the display panel 20 according to the enable signals.

A refresh rate refers to a speed at which the images are updated on a screen when the display panel 20 is working, that is, a number of times of the images displaying on the screen per second. For example, if the images display 60 times per second, the refresh rate is 60 Hz.

It can be understood that by allowing the refresh rates to correspond to the gamma voltages, a displayed brightness of the display panel 20 can be adjusted by adjusting the gamma voltages provided to the display panel 20 when a current refresh rate of the display panel 20 changes. For example, when a refresh rate of the display panel 20 in an N-th frame is 70 Hz, the power control module 30 provides a gamma voltage of 10 V to the display panel 20, and when the refresh rate of the display panel 20 in an (N+1)th frame is switched to 60 Hz, the power control module 30 provides a gamma voltage of 12 V to the display panel 20. Therefore, by improving a displayed brightness when the display panel 20 refreshes the images at a lower refresh rate and/or reducing the displayed brightness when the display panel 20 refreshes the images at a higher refresh rate, the display panel 20 is allowed to maintain a same displayed brightness when refreshing the images both at the lower refresh rate and the higher refresh rate. Therefore, serious flickers of the display device caused by the display device being switched at different refresh rates in a short time can be prevented.

As shown in FIG. 2, the power control module 30 includes a first control module 31 and a power management module 32. The first control module 31 may be a complex programmable logic device (CPLD), and the power management module 32 may be a power management integrated circuit (PMIC).

Wherein, the driving module 10 is further configured to send the enable signals to the first control module 31 when sending the driving signals to the display panel 20. The first control module 31 is configured to confirm the current refresh rate of the display panel 20 according to the enable signals. The power management module 32 is configured to provide the gamma voltages corresponding to the refresh rates of the display panel 20 to the display panel 20 according to the refresh rates of the display panel 20.

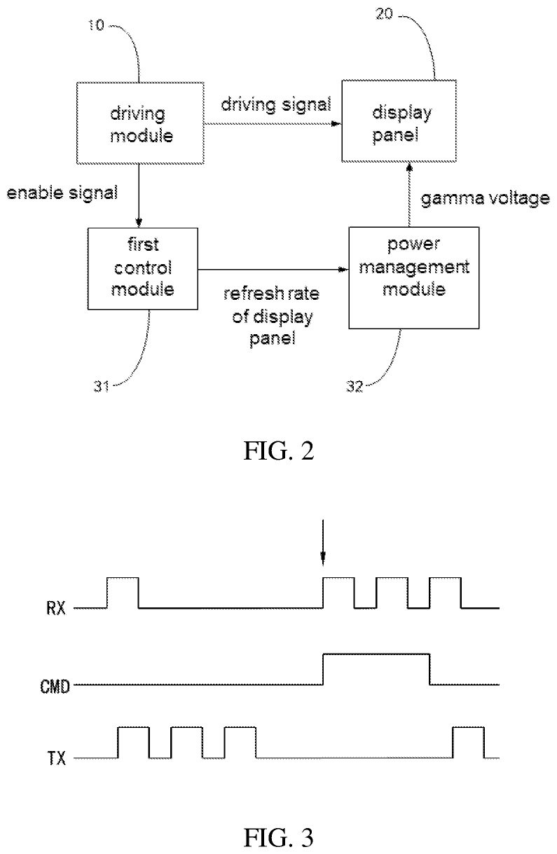

As shown in FIG. 3, it can be understood that the enable signals sent by the driving module 10 to the first control module 31 include first input signals RX and second input signals TX. The first input signals RX represent data enable signals of each row output by a front end to the driving module 10, and the second input signals TX represent data enable signals of each row output by the driving module 10 to the source driver of the display panel 20. The current refresh rate of the display panel 20 can be confirmed according to an interval time between two of the first input signals RX or an interval time between two of the second input signals TX. Therefore, whether the current refresh rate of the display panel 20 has changed can be detected.

Specifically, the first control module 31 is further configured to send control signals CMD to the power management module 32 when the current refresh rate of the display panel 20 is switched from a first frequency to a second frequency. The power management module 32 is further configured to provide the display panel 20 with a gamma voltage corresponding to the second frequency according to the control signals CMD.

As shown in FIG. 3, FIG. 3 is a schematic signal diagram of the enable signals and the control signals CMD when switching the refresh rates according to an embodiment of the present disclosure. A position indicated by the arrow in FIG. 3 is when the first control module 31 detects that the current refresh rate of the display panel 20 is switched from the first frequency to the second frequency. At this time, the first control module 31 starts to send the control signals CMD to the power management module 32.

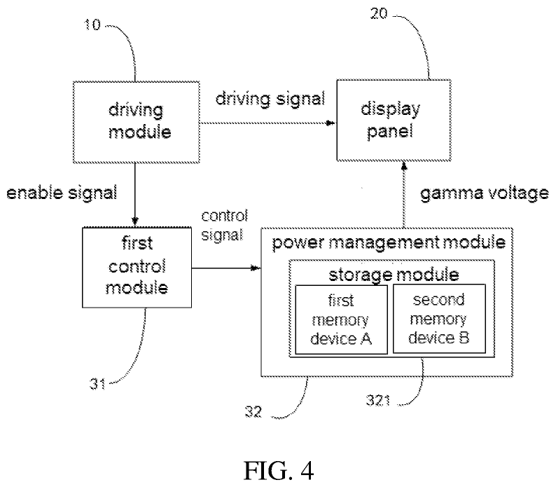

As shown in FIG. 4, the power management module 32 includes a storage module 321 configured to store data of the gamma voltages. The storage module 321 includes a first memory device A and a second memory device B, the first memory device A is configured to store data of a first gamma voltage GM1, and the second memory device B is configured to store data of a second gamma voltage GM2.

It can be understood that the first memory device A and the second memory device B may be used to store different data of the gamma voltages. The power control module 30 can timely adjust the gamma voltages provided to the display panel 20 when the display panel 20 switches the current refresh rate by storing the data of the gamma voltages in the first memory device A and the second memory device B in advance.

In an embodiment, the power management module 32 is further configured to provide the display panel 20 with the gamma voltage corresponding to the second frequency according to the control signals CMD sent by the first control module 31 when the current refresh rate of the display panel 20 is switched from the first frequency to the second frequency and the gamma voltage corresponding to the second frequency is the first gamma voltage GM1 or the second gamma voltage GM2.

It can be understood that when the display panel 20 switches the current refresh rate and a refresh rate after switching corresponds to one of the gamma voltages stored in the first memory device A or the second memory device B, a corresponding gamma voltage can be obtained directly from a corresponding memory device according to the control signals CMD, and the gamma voltage provided to the display panel 20 can be directly switched by delaying one frame to finish.

Wherein, the power management module 32 is further configured to obtain the first gamma voltage GM1 from the first memory device A and provide the first gamma voltage GM1 to the display panel 20 according to the control signals CMD sent by the first control module 31 when the gamma voltage corresponding to the second frequency is the first gamma voltage GM1.

The power management module 32 is further configured to obtain the second gamma voltage GM2 from the second memory device B and provide the second gamma voltage GM2 to the display panel 20 according to the control signals CMD sent by the first control module 31 when the gamma voltage corresponding to the second frequency is the second gamma voltage GM2.

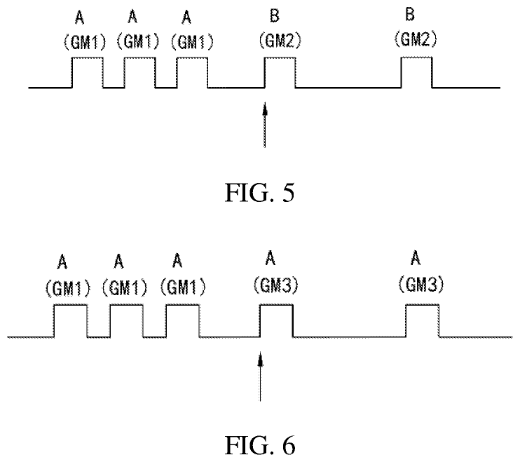

As shown in FIG. 5, FIG. 5 is a schematic signal diagram of the gamma voltages provided by the power management module 32 according to an embodiment of the present disclosure. The first frequency corresponding to the first gamma voltage GM1 and the second frequency corresponding to the second gamma voltage GM2 are taken as an example. A position indicated by the arrow in FIG. 5 is when the first control module 31 detects that the current refresh rate of the display panel 20 is switched from the first frequency to the second frequency. At this time, the first control module 31 sends the control signals CMD to the power management module 32 to control the power management module 32 to switch the gamma voltage provided to the display panel 20 from the first gamma voltage GM1 to the second gamma voltage GM2.

In another embodiment, the first control module 31 is further configured to send data of the gamma voltage corresponding to the second frequency to the power management module 32 when the current refresh rate of the display panel 20 is switched from the first frequency to the second frequency and the gamma voltage corresponding to the second frequency is different from the first gamma voltage GM1 and the second gamma voltage GM2. The power management module 32 is further configured to amend the data in the first memory device A or the second memory device B to the data of the gamma voltage corresponding to the second frequency according to the data of the gamma voltage corresponding to the second frequency sent by the first control module 31.

It can be understood that when the display panel 20 switches the current refresh rate and the refresh rate after switching corresponds to a gamma voltage that is different from the gamma voltage stored in the first memory device A or the second memory device B, the power management module 32 does not have data of the gamma voltage corresponding to the refresh rate after switching. At this time, the first control module 31 transmits the data of the gamma voltage corresponding to the refresh rate after switching to the power management module 32. At a same time, the control signals CMD are used to control the power management module 32 to amend the data in the first memory device A or the second memory device B and control the power management module 32 to switch the gamma voltage provided to the display panel 20 to the gamma voltage corresponding to the refresh rate after switching. The above switching action can be completed by delaying two frames.

As shown in FIG. 6, FIG. 6 is a schematic signal diagram of the gamma voltages provided by the power management module 32 according to an embodiment of the present disclosure. The first frequency corresponding to the first gamma voltage GM1, the second frequency corresponding to a third gamma voltage GM3, and the data in the first memory device A being amended are taken as an example. A position indicated by the arrow in FIG. 6 is when the first control module 31 detects that the current refresh rate of the display panel 20 is switched from the first frequency to the second frequency. At this time, the first control module 31 sends the control signals CMD and the data of the gamma voltage corresponding to the second frequency to the power management module 32 to control the power management module 32 to amend the data in the first memory device A to data of the third gamma voltage GM3 and to control the power management module 32 to switch the gamma voltage provided to the display panel 20 from the first gamma voltage GM1 to the third gamma voltage GM3.

Specifically, the first control module 31 may be connected to the power management module 32 by an inter-integrated circuit (I2C) bus, and the first control module 31 is further configured to transmit the data of the gamma voltages and the control signals CMD to the power management module 32 by the I2C bus.

It should be noted that if the first control module 31 directly transmits all the data of the gamma voltages to the power control module 30 at a same time, the data entering a display area of the display panel 20 will be always updated due to excessive data transmission, thereby resulting in display images being abnormal. The present disclosure stores two data of the gamma voltages in registers of the power management module 32 in advance, and meanwhile, the first control module 31 confirms and transmits the data of the corresponding gamma voltage to the power management module 32 according to the refresh rate of the display panel 20 after switching, and timely renews and amends the data in the registers. Therefore, the present disclosure can prevent the above problem.

Specifically, the gamma voltages correspond to refresh rate ranges by one to one, that is, one of the refresh rate ranges corresponds to one of the gamma voltages.

Wherein, each of the refresh rate ranges is different, that is, any two refresh rate ranges do not contain a same refresh rate, and a number of the refresh rates included in each of the refresh rate ranges can be same or different.

It should be noted that one refresh rate range means a collection of the refresh rates in a certain range. For example, a refresh rate range ranging from 50 to 60 Hz means a collection of all refresh rates in the range of 50 to 60 Hz. A general adjusting range of the refresh rates in the display device ranges from 48 to 240 Hz. The adjusting range of the refresh rates may be divided into m refresh rate ranges, such as two refresh rate ranges of 48 to 120 Hz and 121 to 240 Hz.

It can be understood that on the premise of ensuring display quality of the display panel 20, a number of the gamma voltages and corresponding data thereof can be reduced by making the gamma voltages correspond to the refresh rate ranges by one to one. Therefore, a burden of data transmission and storage can be reduced.

It should be noted that when the display device is working, a plurality of key refresh rates may be selected from the adjusting range of the refresh rates. The key refresh rates are set as switching threshold values, and two adjacent switching threshold values and the refresh rates in the range thereof are set as one refresh rate range corresponding to one gamma voltage. For example, a first refresh rate range corresponds to the first gamma voltage GM1, and a second refresh rate range corresponds to the second gamma voltage GM2.

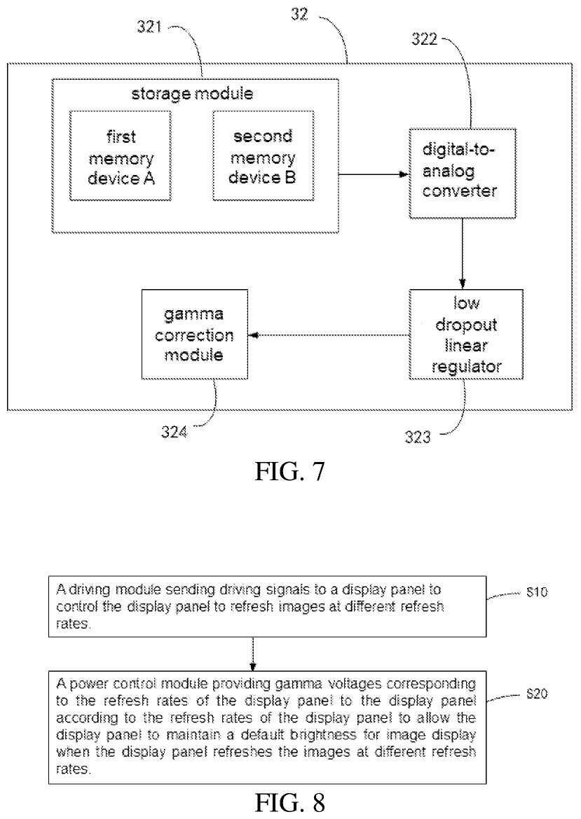

As shown in FIG. 7, in an embodiment, the power management module 32 further includes a digital-to-analog converter 322 (DAC), a low dropout linear regulator 323, and a gamma correction module 324.

Wherein, the data of the gamma voltages sent by the first control module 31 through the I2C bus is stored in the storage module 321, digital signals output by the storage module 321 is converted into analog signals by the digital-to-analog converter 322, and then the analog signals are input to the low dropout linear regulator 323 and the gamma correction module 324. The low dropout linear regulator 323 generates gamma reference voltages Vref according to the input analog signals and analog voltages AVDD for gamma correction, then the low dropout linear regulator 323 outputs common gamma reference voltage Vref to the gamma correction module 324, and the gamma correction module 324 outputs the gamma voltages according to the gamma reference voltages Vref.

It should be noted that adjustment of all gamma voltages may be indirectly controlled by adjusting the low dropout linear regulator 323, and each of the gamma voltages may also be adjusted using the gamma correction module 324.

As shown in FIG. 8, based on the above display device, the present disclosure further provides a driving method of the display device. The display device includes the driving module 10, the display panel 20, and the power control module 30, and the driving method of the display device includes following steps.
S10: The driving module 10 sending the driving signals to the display panel 20 to control the display panel 20 to refresh the images at different refresh rates; and
S20: the power control module 30 providing the gamma voltages corresponding to the refresh rates of the display panel 20 to the display panel 20 according to the refresh rates of the display panel 20 to allow the display panel 20 to maintain the default brightness for image display when the display panel 20 refreshes the images at different refresh rates.

Wherein, the power control module 30 includes the first control module 31 and the power management module 32.

The step S10 includes a following step: the driving module 10 sending the enable signals to the first control module 31 when sending the driving signals to the display panel 20.

The step S20 includes following steps:
S21: the first control module 31 confirming the current refresh rate of the display panel 20 according to the enable signals; and
S22: the power management module 32 providing the gamma voltages corresponding to the refresh rates of the display panel 20 to the display panel 20 according to the refresh rates of the display panel 20.

Specifically, the step S21 includes a following step:
S211: the first control module 31 sending the control signals CMD to the power management module 32 when the current refresh rate of the display panel 20 is switched from the first frequency to the second frequency.

The step S22 includes a following step:
S221: the power management module 32 providing the display panel the gamma voltage corresponding to the second frequency according to the control signals CMD.

Specifically, the power management module 32 includes the storage module 321 configured to store the data of the gamma voltages. The storage module 321 includes the first memory device A and the second memory device B, the first memory device A is configured to store the data of the first gamma voltage GM1, and the second memory device B is configured to store the data of the second gamma voltage GM2.

In an embodiment, the step S221 includes a following step: the power management module 32 providing the display panel 20 the gamma voltage corresponding to the second frequency according to the control signals CMD sent by the first control module 31 when the current refresh rate of the display panel 20 is switched from the first frequency to the second frequency and the gamma voltage corresponding to the second frequency is the first gamma voltage GM1 or the second gamma voltage GM2.

Wherein, the power management module 32 obtains the first gamma voltage GM1 from the first memory device A and provides the first gamma voltage GM1 to the display panel 20 according to the control signals CMD sent by the first control module 31 when the gamma voltage corresponding to the second frequency is the first gamma voltage GM1.

The power management module 32 obtains the second gamma voltage GM2 from the second memory device B and provides the second gamma voltage GM2 to the display panel 20 according to the control signals CMD sent by the first control module 31 when the gamma voltage corresponding to the second frequency is the second gamma voltage GM2.

In an embodiment, the step S211 includes a following step: the first control module 31 sending the data of the gamma voltage corresponding to the second frequency to the power management module 32 when the current refresh rate of the display panel 20 is switched from the first frequency to the second frequency and the gamma voltage corresponding to the second frequency is different from the first gamma voltage GM1 and the second gamma voltage GM2.

The step S211 further includes a following step: the power management module 32 amending the data in the first memory device A or the second memory device B to the data of the gamma voltage corresponding to the second frequency according to the data of the gamma voltage corresponding to the second frequency sent by the first control module 31.

Specifically, the gamma voltages correspond to the refresh rate ranges by one to one.

Based on a same inventive concept, an embodiment of the present disclosure further provides a display equipment, which includes the display device mentioned above. A structure and beneficial effects of the display equipment is same as the display device. The display device has been described in detail in the above embodiments, so it will not be iterated herein for the sake of conciseness.

Beneficial effects of the present disclosure are that by allowing the refresh rates to correspond to the gamma voltages, the displayed brightness of the display panel 20 can be adjusted by adjusting the gamma voltages provided to the display panel 20 when the current refresh rate of the display panel 20 changes. Therefore, the brightness difference of the display panel 20 can be improved when the display panel 20 refreshes the images at the lower refresh rate and the higher refresh rate by improving the displayed brightness when the display panel 20 refreshes the images at the lower refresh rate and/or reducing the displayed brightness when the display panel 20 refreshes the images at the higher refresh rate. The display panel 20 is allowed to maintain the same brightness for image display when the display panel 20 refreshes the images at different refresh rates. Therefore, serious flickers of the display device caused by the display device being switched at different refresh rates in the short time can be prevented.

It can be understood that for a person of ordinary skill in the art, equivalent replacements or changes can be made according to the technical solution of the present disclosure and its inventive concept, and all these changes or replacements should fall within the protection scope of the claims attached to the present disclosure.

1. A display device, comprising a driving module, a display panel, and a power control module;
wherein the driving module is configured to send driving signals to the display panel to control the display panel to refresh images at different refresh rates; and
the power control module is configured to provide gamma voltages corresponding to the refresh rates of the display panel to the display panel according to the refresh rates of the display panel to allow the display panel to maintain a default brightness for image display when the display panel refreshes the images at different refresh rates.

2. The display device according to claim 1, wherein the power control module comprises a first control module and a power management module;
the driving module is further configured to send enable signals to the first control module when sending the driving signals to the display panel;
the first control module is configured to confirm the refresh rates of the display panel according to the enable signals; and
the power management module is configured to provide the gamma voltages corresponding to the refresh rates of the display panel to the display panel according to the refresh rates of the display panel.

3. The display device according to claim 2, wherein the first control module is further configured to send control signals to the power management module when a current refresh rate of the display panel is switched from a first frequency to a second frequency; and
the power management module is further configured to provide the display panel with a gamma voltage corresponding to the second frequency according to the control signals.

4. The display device according to claim 3, wherein the power management module comprises a storage module configured to store data of the gamma voltages, the storage module comprises a first memory device and a second memory device, the first memory device is configured to store data of a first gamma voltage, and the second memory device is configured to store data of a second gamma voltage.

5. The display device according to claim 4, wherein the power management module is further configured to provide the display panel with the gamma voltage corresponding to the second frequency according to the control signals sent by the first control module when the current refresh rate of the display panel is switched from the first frequency to the second frequency and the gamma voltage corresponding to the second frequency is the first gamma voltage or the second gamma voltage.

6. The display device according to claim 5, wherein the power management module is further configured to obtain the first gamma voltage from the first memory device and provide the first gamma voltage to the display panel according to the control signals sent by the first control module when the gamma voltage corresponding to the second frequency is the first gamma voltage.

7. The display device according to claim 5, wherein the power management module is further configured to obtain the second gamma voltage from the second memory device and provide the second gamma voltage to the display panel according to the control signals sent by the first control module when the gamma voltage corresponding to the second frequency is the second gamma voltage.

8. The display device according to claim 4, wherein the first control module is further configured to send data of the gamma voltage corresponding to the second frequency to the power management module when the current refresh rate of the display panel is switched from the first frequency to the second frequency and the gamma voltage corresponding to the second frequency is different from the first gamma voltage and the second gamma voltage; and
the power management module is further configured to amend the data in the first memory device or the second memory device to the data of the gamma voltage corresponding to the second frequency according to the data of the gamma voltage corresponding to the second frequency sent by the first control module.

9. The display device according to claim 1, wherein the gamma voltages correspond to refresh rate ranges by one to one.

10. A display equipment, comprising a display device, wherein the display device comprises a driving module, a display panel, and a power control module;
wherein the driving module is configured to send driving signals to the display panel to control the display panel to refresh images at different refresh rates;
the power control module is configured to provide gamma voltages corresponding to the refresh rates of the display panel to the display panel according to the refresh rates of the display panel to allow the display panel to maintain a default brightness for image display when the display panel refreshes the images at different refresh rates;
wherein the power control module comprises a first control module and a power management module;
the driving module is further configured to send enable signals to the first control module when sending the driving signals to the display panel;
the first control module is configured to confirm the refresh rates of the display panel according to the enable signals; and
the power management module is configured to provide the gamma voltages corresponding to the refresh rates of the display panel to the display panel according to the refresh rates of the display panel.

11. The display equipment according to claim 10, wherein the first control module is further configured to send control signals to the power management module when a current refresh rate of the display panel is switched from a first frequency to a second frequency; and
the power management module is further configured to provide the display panel with a gamma voltage corresponding to the second frequency according to the control signals.

12. The display equipment according to claim 11, wherein the power management module comprises a storage module configured to store data of the gamma voltages, the storage module comprises a first memory device and a second memory device, the first memory device is configured to store data of a first gamma voltage, and the second memory device is configured to store data of a second gamma voltage.

13. The display equipment according to claim 12, wherein the power management module is further configured to provide the display panel with the gamma voltage corresponding to the second frequency according to the control signals sent by the first control module when the current refresh rate of the display panel is switched from the first frequency to the second frequency and the gamma voltage corresponding to the second frequency is the first gamma voltage or the second gamma voltage.

14. The display equipment according to claim 13, wherein the power management module is further configured to obtain the first gamma voltage from the first memory device and provide the first gamma voltage to the display panel according to the control signals sent by the first control module when the gamma voltage corresponding to the second frequency is the first gamma voltage.

15. The display equipment according to claim 13, wherein the power management module is further configured to obtain the second gamma voltage from the second memory device and provide the second gamma voltage to the display panel according to the control signals sent by the first control module when the gamma voltage corresponding to the second frequency is the second gamma voltage.

16. The display equipment according to claim 12, wherein the first control module is further configured to send data of the gamma voltage corresponding to the second frequency to the power management module when the current refresh rate of the display panel is switched from the first frequency to the second frequency and the gamma voltage corresponding to the second frequency is different from the first gamma voltage and the second gamma voltage; and
the power management module is further configured to amend the data in the first memory device or the second memory device to the data of the gamma voltage corresponding to the second frequency according to the data of the gamma voltage corresponding to the second frequency sent by the first control module.

17. The display equipment according to claim 10, wherein the gamma voltages correspond to refresh rate ranges by one to one.

18. A driving method of a display device, wherein the display device comprises a driving module, a display panel, and a power control module, the driving method of the display device comprising following steps:
S10: the driving module sending driving signals to the display panel to control the display panel to refresh images at different refresh rates; and
S20: the power control module providing gamma voltages corresponding to the refresh rates of the display panel to the display panel according to the refresh rates of the display panel to allow the display panel to maintain a default brightness for image display when the display panel refreshes the images at different refresh rates.
